(19) United States
(12) Patent Application Publication
(10) Pub. No.: US 2026/0181760 A1
(43) Pub. Date: Jun. 25, 2026

(54) LIGHT EMITTING DIODE (LED) DRIVER FOR A STACKED LED DRIVER ILLUMINATION SYSTEM

(71) Applicant: TEXAS INSTRUMENTS INCORPORATED, Dallas, TX (US)

(72) Inventors: Jiana Lou, Shanghai (CN); Hao Chen, Ningbo (CN); Zhiqian Wu, Xian (CN)

(21) Appl. No.: 19/000,852

(22) Filed: Dec. 24, 2024

(51) Int. Cl. H05B 47/165; H05B 45/325; H05B 47/16

(52) U.S. Cl. CPC H05B 47/165; H05B 45/325; H05B 47/16

(57) ABSTRACT

A control logic circuit has a configuration and PWM inputs and first to third control outputs. The configuration input receives a value indicative of a leader/follower status and generate a first signal at the first control output indicative of a first/second status, a second signal at the second control output indicative of a first dimming status, and a third signal at the third control output indicative of a second dimming status. A clock circuit includes an oscillator to generate an oscillator clock and having first through third control inputs, a clock output, and a synchronization terminal. The clock circuit is configured to: in response to the first status, generate a first clock based on a synchronization clock, and in response to the second status, generate the first clock based on the oscillator clock and generate a synchronization clock also based on the oscillator clock.

### BACKGROUND

Many types of displays are backlit meaning that the display has illumination devices such as light emitting diodes (LEDS) behind the display to illuminate the display to the viewer. Large displays may benefit from more LEDs to provide backlighting. An LED driver can operate only a certain number of LEDs, which may not be a sufficient number of LEDs given the display size.

### SUMMARY

In an example, an apparatus includes a control logic circuit having a configuration input, a pulse width modulation (PWM) input, a first control output, a second control output, and a third control output. The configuration input is configured to receive a configuration value indicative of a first status or a second status. The control logic is configured to generate a first signal at the first control output indicative of a first status or a second status, a second signal at the second control output indicative of a first dimming status, and a third signal at the third control output indicative of a second dimming status. A switching converter controller has a clock input. A clock circuit includes an oscillator configured to generate an oscillator clock. The clock circuit has a first control input, a second control input, a third control input, a clock output, and a synchronization terminal. The clock output is coupled to the clock input. The clock circuit is configured to: in response to the first status, generate a first clock at the clock output based on a synchronization clock received at the synchronization terminal; and in response to the second status, generate the first clock at the clock output based on the oscillator clock and generate a synchronization clock at the synchronization terminal also based on the oscillator clock.

An apparatus includes a control logic circuit having a configuration input, a pulse width modulation input and first, second, and third control outputs. The configuration input configured to receive a configuration value indicative of a first/second status and generate a first signal at the first control output indicative of a first/second status, a second signal at the second control output indicative of a first dimming status, and a third signal at the third control output indicative of a second dimming status. A clock circuit includes an oscillator to generate an oscillator clock and having first, second, and third control inputs, a clock output, and a synchronization terminal. The clock circuit to: in response to the first status, generate a first clock at the clock output based on a synchronization clock received at the synchronization terminal, and in response to the second status, generate the first clock at the clock output based on the oscillator clock and generate a synchronization clock at the synchronization terminal also based on the oscillator clock.

In yet another example, an illumination system includes a first light emitting diode (LED) driver having a first configuration interface and a first switching converter controller and having a first LED output terminal. The first LED driver is configured to be either a leader or a follower based on configuration information received at the first configuration interface. A first power stage is coupled to the first LED driver and has a first output voltage terminal. A first set of LEDs is coupled between the first output voltage terminal and the first LED output terminal. A second LED driver has a second configuration interface and a second switching converter controller and has a second LED output terminal. The second LED driver is configured to be the other of the leader or follower based on configuration information received at the second configuration interface. A second power stage is coupled to the second LED driver and has a second output voltage terminal coupled to the first output voltage terminal. A second set of LEDs is coupled between the second output voltage terminal and the second LED output terminal. Whichever of the first or second LED drivers is configured to be the follower, such first or second LED driver is configured to generate a first clock for its respective first or second switching converter controller and to provide a second clock to the other of the first or second LED drivers configured to the leader.

In another example, an illumination system includes a first light emitting diode (LED) driver having a first configuration interface and a first switching converter controller and has a first LED output terminal. The first LED driver is configured to be either a leader or a follower based on configuration information received at the first configuration interface. A first power stage is coupled to the first LED driver and has a first output voltage terminal. A first set of LEDs is coupled between the first output voltage terminal and the first LED output terminal. A second LED driver has a second configuration interface and a second switching converter controller and has a second LED output terminal. The second LED driver is configured to be the other of the leader or follower based on configuration information received at the second configuration interface. A second power stage is coupled to the second LED driver and has a second output voltage terminal coupled to the first output voltage terminal. A second set of LEDs is coupled between the second output voltage terminal and the second LED output terminal. Whichever of the first or second LED drivers is configured to be the leader, such first or second LED driver is configured to generate a first clock for its respective first or second switching converter controller based on a second clock received from the other of the first or second LED drivers that configured to the follower.

### BRIEF DESCRIPTION OF THE DRAWINGS

FIGS. 1A and 1B (collectively, FIG. 1) are a diagram of an illumination system including multiple LED drivers and LEDs associated with each such LED driver, in an example.

FIG. 2 is a block diagram of an LED driver usable as either or both of the LED drivers in the illumination system of FIG. 1, in an example.

FIG. 3 is a schematic diagram of a clock circuit in the LED driver of FIG. 2, in an example.

FIG. 4 is a schematic diagram of a switching converter controller in the LED driver of FIG. 2, in an example.

FIG. 5 is a flowchart illustrating the operation of an LED driver configured to be a follower LED driver, in an example.

FIG. 6 is a flowchart illustrating the operation of an LED driver configured to be a leader LED driver, in an example.

FIGS. 7-11 are timing diagrams illustrating the operation of the follower and leader LED drivers in the illumination system of FIG. 1 in various pulse width modulation (PWM) configurations, in an example.

### DETAILED DESCRIPTION

The same reference numbers or other reference designators are used in the drawings to designate the same or similar (either by function and/or structure) features.

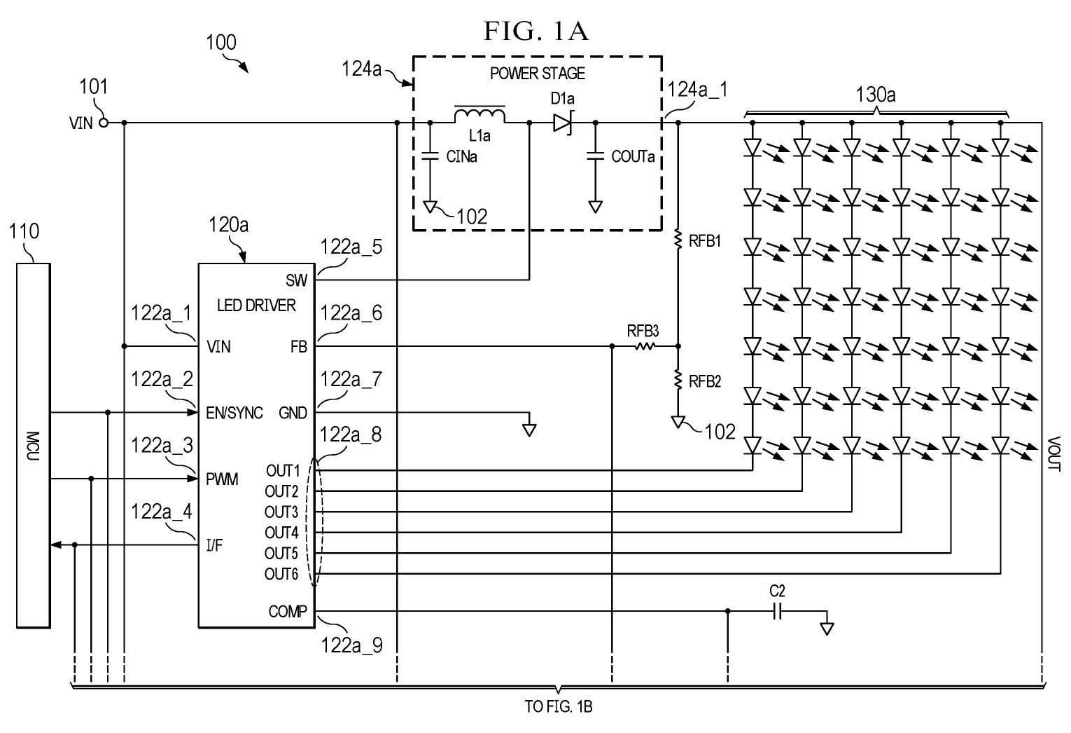

FIG. 1 is a diagram of an illumination system 100 including LED drivers 120a and 120b (collectively, LED drivers 120). LED driver 120a has an input voltage terminal 122a_1, an enable (EN)/synchronization (SYNC) terminal 122a_2, a pulse width modulation (PWM) input 122a_3, an interface terminal 122a_4, a switching terminal 122a_5, a feedback (FB) terminal 122a_6, a ground terminal 122a_7, one or more LED output terminals 122a_8, and a compensation (COMP) terminal 122a_9. Similarly, LED driver 120b has an input voltage terminal 122b_1, an EN/SYNC terminal 122b_2, a PWM input 122b_3, an interface terminal 122b_4, a switching terminal 122b_5, an FB terminal 122b_6, a ground terminal 122b_7, multiple LED output terminals 122b_8, and a COMP terminal 122b_9.

Each LED driver 120 includes a switching converter controller coupled to a power stage. For example, LED driver 120a is coupled to power stage 124a, and LED driver 120b is coupled to power stage 124b. Power stages 124a and 124b (collectively, power stages 124) may be boost converter power stages, buck converter power stages, buck-boost converter power stages, etc. In the example of FIG. 1, power stages 124 are boost converter power stages. Power stage 124a includes an inductor L1a, a diode D1a, and capacitors CINa and COUTa. A terminal of inductor L1a and capacitor CINa is coupled to an input voltage (VIN) terminal 101. The other terminal of capacitor CINa is coupled to another supply voltage (e.g., ground) terminal 102. The other terminal of inductor L1a is coupled to the anode of diode D1a. Capacitor COUTa is coupled between the cathode of diode D1a and ground. Similarly, power stage 124b includes an inductor L1b, a diode D1b, and capacitors CINb and COUTb. A terminal of inductor L1b and capacitor CINb is coupled to the input voltage terminal 101. The other terminal of capacitor CINb is coupled to supply voltage terminal 102. The other terminal of inductor L1b is coupled to the anode of diode D1b. Capacitor COUTb is coupled between the cathode of diode D1b and ground. Power stage 124a has an output 124a_1 which is coupled to terminal of the capacitor C1a coupled to the cathode of diode D1a. Similarly, power stage 124b has an output 124b_1 which is coupled to terminal of the capacitor C1b coupled to the cathode of diode D1b. The power stage outputs 124a_1 and 124b_1 of the power stages 124 are coupled together to provide a single output voltage VOUT.

Each LED driver output 122a_8, 122b_8 can be coupled to a serial string of one or more LEDs. LEDs 130a are coupled to LED driver 120a, and LEDs 130b are coupled to LED driver 120b. In the example of FIG. 1, LED driver 122a has seven LED driver outputs 122a_8, and each respective LED driver output 122a_8 is coupled to the cathode of a string of seven LEDs. The anode of the top-most LED in each string is coupled to the power stage output 124a_1. Similarly, LED driver 122b has seven LED driver outputs 122b_8, and each respective LED driver output 122b_8 is coupled to the cathode of a string of seven LEDs. The anode of the top-most LED in each string is coupled to the power stage output 124b_1.

System 100 also includes a microcontroller unit (MCU) 110 which is coupled to LED drivers 120a and 120b. MCU 110 has terminals that are coupled to the EN/SYNC terminals 112a_2/122b_2, PWM terminals 122a_3/122b_3, and interface terminals 122a_4/122b_4. The interface terminals 122a_4/122b_4 may provide communication connectivity between MCU 110 and LED drivers 120a and 120b by way of a serial interface such as the Inter-Integrated Chip (I2C), Serial Peripheral Interface (SPI), etc. In an example, through the interface terminals 122a_4/122b_4, MCU 110 can program one of the LED drivers to be a “leader” and the other LED driver to be a “follower.” The roles of leader and follower for the LED drivers 120a, 120b are described below. MCU 110 can enable and disable each LED driver 120a, 120b through a logic signal provided to the EN/SYNC terminals 122a_2/122b_2. When an LED driver is enabled, MCU 110 can provide a PWM signal to the PWM terminal 122a_3/122b_3 of such LED driver. The PWM signal causes the LED driver to turn on and off its respective LEDs 130a/130b at a frequency and duty cycle of the PWM signal. The frequency of on and off phases of the LEDS 130a/130b is faster than the frequency response of the human eye. The human eye detects the intensity of the light produced by the blinking LEDs 130a/130b to be a function of the duty cycle at which the PWM driver 120 operates the LEDs. Accordingly, MCU 110 can command each LED driver 120 separately or together to activate PWM dimming based on the PWM signal provided by the MCU to the respective LED driver 120. For example, MCU 110 can activate PWM dimming for LED driver 120a but not for LED driver 120b, and vice versa.

Resistors RFB1, RFB2, and RFB3 are coupled together as shown between power stage output 124a_1 and the FB terminals 122a_6/122b_6 of LED drivers 120a/120b. The voltage at the FB terminals 122a_6/122b_6 is proportional to VOUT. Capacitor C2 is coupled between COMP terminals 122a_9/122b_9 and ground, and capacitor C2 provides loop stability.

As noted above, MCU 110 can configure one of the LED drivers to be the leader and the other LED driver to be the follower. The names “leader” and “follower” refer to the roles described herein. Each LED driver 120 includes a switching converter controller which provides a connection, via its switching terminal 122a_5/122b_5 to the respective power stage 124. Although both switching converter controllers include an error amplifier to amplify the difference between VOUT (via its proxy at the FB terminal 122a_6/122b_6) and a reference voltage, the error amplifier is enabled in the LED driver 120 that is configured to be the leader while the error amplifier is disabled in the LED driver 120 that is configured to be the follower. Further, one of the LED drivers 120 generates a clock for use by its switching converter controller and provides a clock to the other LED driver for use by its switching converter. In one example, the follower LED driver 120 generates a clock for its switching converter controller and provides a clock to the leader LED driver for use by the leader LED driver’s switching converter controller. The leader LED driver 120 phase-delays the clock received from the follower LED driver 120 by approximately 180 degrees and uses the phase-delayed clock for its switching converter controller. By ensuring that the clocks for use by the two switching converter controllers are out of phase with respect to each other, the electromagnetic interference (EMI) generated by the switching converters of the LED drivers 120 will be at a substantially higher frequency than the frequency of the individual clocks (e.g., double the frequency), which advantageously allows the EMI to be easily attenuated by an EMI filter (not shown). If MCU 110 discontinues PWM dimming to the follower LED driver but provides PWM diming for the leader LED driver, the follower LED driver will discontinue providing a clock to the leader LED driver and the leader LED driver will nevertheless continue to generate a clock for its switching converter controller using instead an oscillator that is internal to the leader LED driver. If MCU 110 discontinues PWM dimming to the leader LED driver but provides PWM diming for the follower LED driver, the follower LED driver will continue providing a clock to the leader LED driver and, despite PWM diming being discontinued to the leader LED driver, the leader LED driver will continue to generate a clock for its switching converter controller based on the clock provided by the follower LED driver. These clocking examples and other clocking examples are described below.

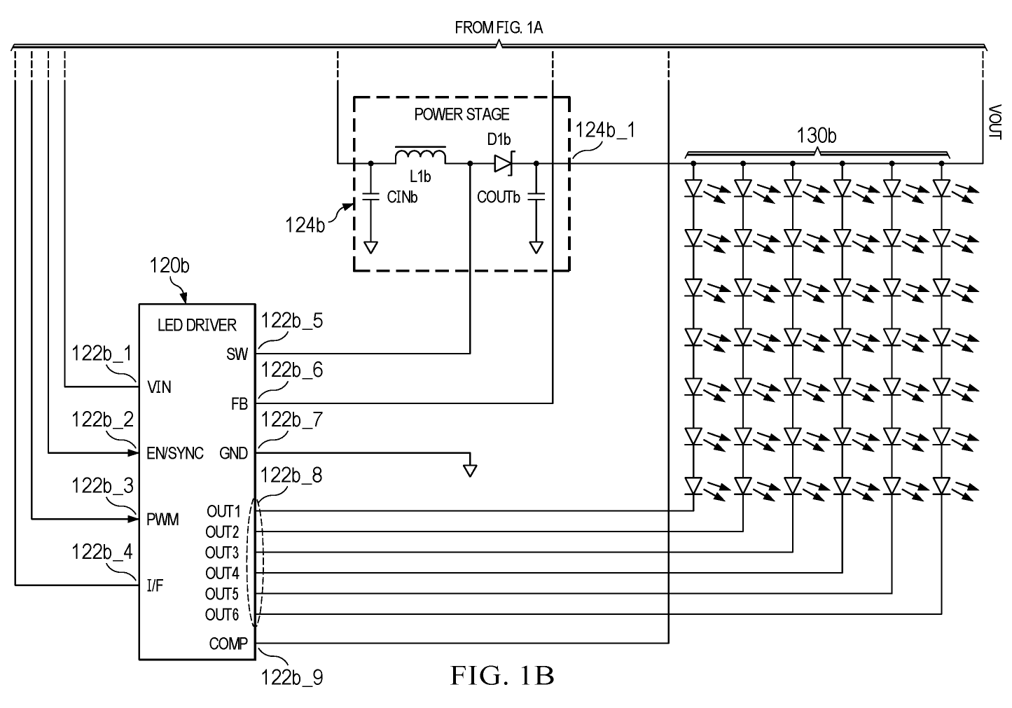

FIG. 2 is a block diagram of an LED driver 120 (e.g., LED driver 120a). The same block diagram can be used to implement either or both LED drivers 120a, 120b. In the example of FIG. 2, LED driver 120a includes a control logic circuit 202, a switching converter controller 204 (e.g., a boost converter controller), and a clock circuit 206. Control logic circuit 202 has inputs 202e and 202f, control outputs 202a, 202b, 202c, and 202d. Switching converter controller 204 has a clock input 204a, a switching terminal 204b, control inputs 204c and 204d, and inputs 204e. Switching converter controller 204 also has a feedback input (not shown in FIG. 2), which receives the feedback voltage from the resistor divider described above from FB terminal 122a_6. Clock circuit 206 has control inputs 206a, 206b, and 206c, a clock output 206d, a control output 206e, and a synchronization terminal 206f.

Interface terminal 122a_4 is coupled to input 202e of control logic circuit 202. PWM terminal 122a_3 is couple to input 202f of control logic circuit 202. Control outputs 202a, 202b, and 202c of control logic circuit 202 are coupled to respective control inputs 206a, 206b, and 206c of clock circuit 206. LED driver 120a also includes current sink circuits 208—one sink circuit 208 connected to each string of LEDs 130a. Each current sink circuit 208 has a control input 208a coupled to a respective control output 202d of control logic circuit 202. The voltage across each current sink circuit 208 is provided to a respective input 204e of switching converter controller 204, which adjusts the magnitude of the output voltage VOUT based on the voltage drop across the strings of LEDs 130a. Clock output 206d of clock circuit 206 is coupled to clock input 204a of switching converter controller 204. Control output 206e of clock circuit 206 is coupled to control input 204d of switching converter controller 204. EN/SYNC terminal 122a_2 of the LED driver 120a is coupled to the synchronization terminal 206f of clock circuit 206. Switching terminal 204b of switching converter controller 204 is coupled to switching terminal 122a_5 of LED driver 120a. EN/SYNC terminal 122a_2 of the LED driver 120a is coupled to the synchronization terminal 206f of clock circuit 206.

MCU 110 can provide a configuration value to the interface terminal 122a_4 of LED driver 120a. The configuration value may be indicative of a first status or a second status. For example, the first status may indicate that the LED driver is to function as a leader LED driver, and the second status may indicate that the LED driver is to function as a follower LED driver. The configuration value is provided to control logic 202. Control logic 202 generates a Follower_Leader signal 201 at its control output 202a to indicate whether the LED driver is a leader or follower. In one example, if the configuration value from MCU 110 is that the LED driver 120 is to function as the leader, control logic 202 asserts the Follower_Leader signal to a logic high state, and if the configuration is that the LED driver is to function as the follower, control logic 202 asserts the Follower_Leader signal to a logic low state.

The Follower_Leader signal is provided to clock circuit 206 and to switching converter controller 204. If the Follower_Leader signal is logic low (indicative of the follower role for the LED driver), clock circuit 206 generates a CLOCK_OUT signal 209 to switching converter controller 204 based on a clock from an oscillator internal to clock circuit 206. Switching converter controller 204 uses the CLOCK_OUT signal 209 to operate its switching behavior, as described below. Clock circuit 206 also generates a SYNC signal 211 at its synchronization terminal 206f. SYNC signal is a clock signal derived from the clock circuit’s internal oscillator and is provided to the leader LED driver for use by its switching converter controller.

If, however, the Follower_Leader signal is logic high (indicative of the leader role for the LED driver), clock circuit 206 receives the SYNC signal 211 from the follower LED driver, phase-delays the received SYNC signal 211 by approximately 180 degrees, and uses the phase-delayed SYNC signal to generate the CLOCK_OUT signal 209 to switching converter 204. Clock circuit 206 also determines whether the SYNC signal is present at the synchronization terminal 206f. If the SYNC signal 211 is present, then as described above, clock circuit 206 generates the CLOCK_OUT signal 209 based on a phase-delayed version of the SYNC signal. If the SYNC signal 211 is not present, then clock circuit 206 continues to generate the CLOCK_OUT signal 209 based on a clock signal from the oscillator internal to clock circuit 206.

Control logic 202 also receives both PWM signals for the LED drivers at its input 202f from MCU 110. The PWM signals toggle high and low at a prescribed frequency and duty cycle to provide dimming information to respective LED driver 120. Depending on which PWM signal is active (toggles high and low), control logic circuit 202 asserts (e.g., logic high) the corresponding Leader_Dimming signal 203 or Follower_Dimming signal 205 to clock circuit 206. If both PWM signals are active, then control logic circuit 202 asserts both the Leader_Dimming signal 203 and the Follower_Dimming signal 205 to clock circuit 206.

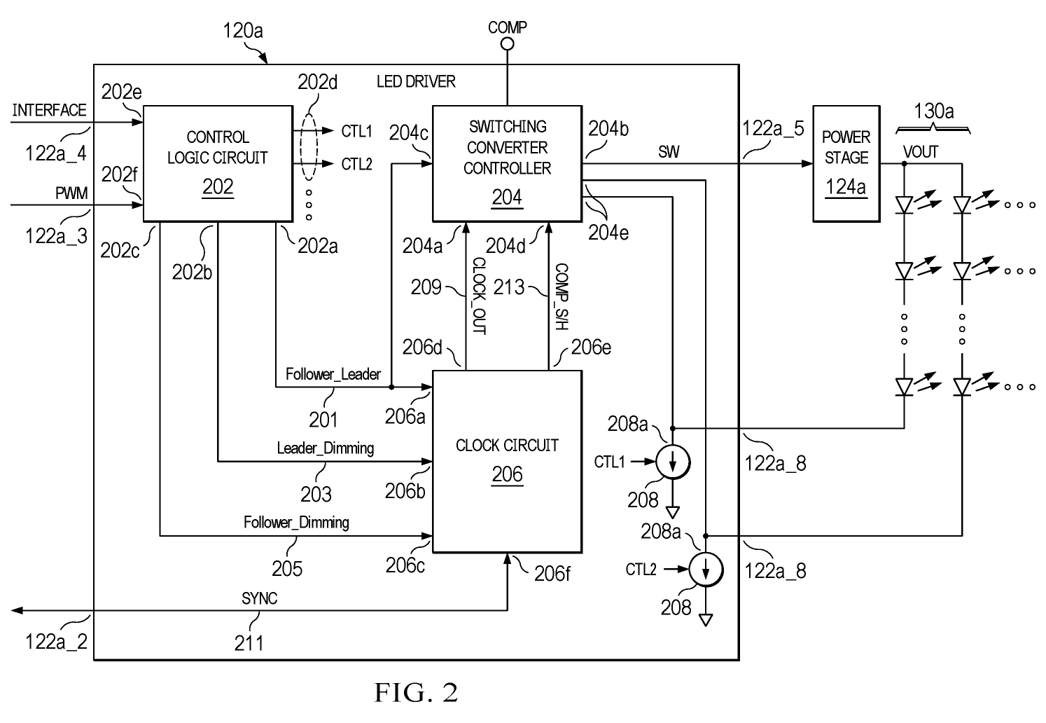

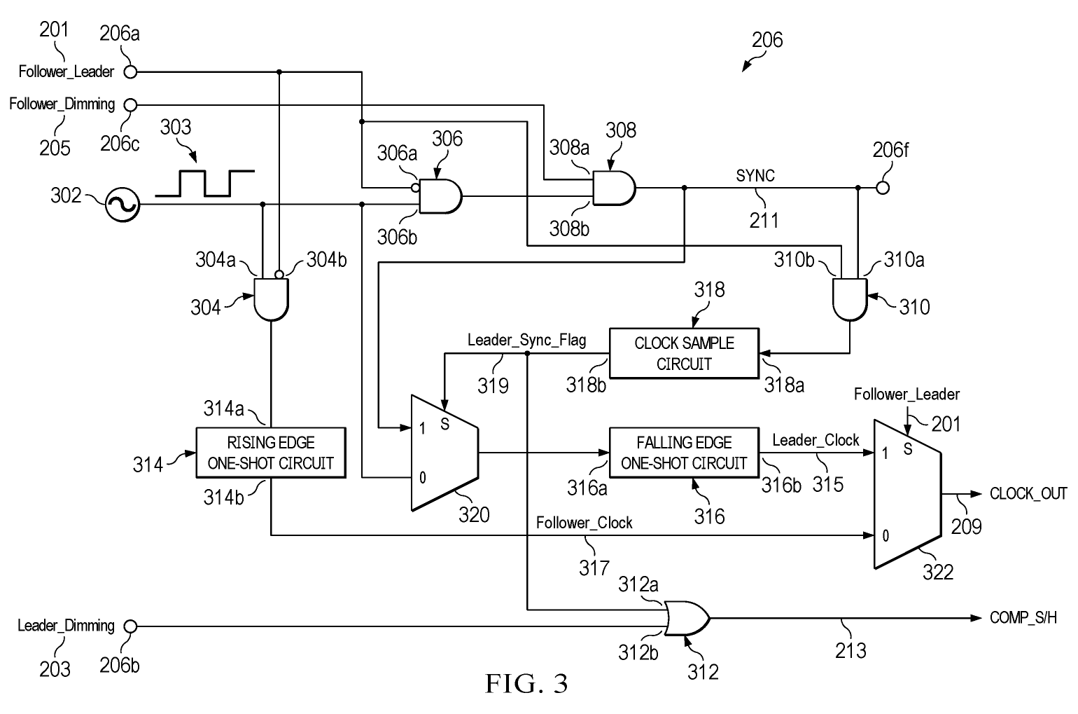

Each LED driver 120 includes an error amplifier coupled to or part of the LED driver’s switching converter controller 204. In some examples, the error amplifier in the follower LED driver is disabled and the error amplifier in the leader LED driver is enabled. However, the error amplifier in the leader LED driver is enabled based on a COMP_sample/hold (S/H) signal 213 from clock circuit 206. In one example, clock circuit 206 asserts the COMP_S/H signal 213 logic high if either or both of the following conditions are present: that the Leader Dimming signal 213 is logic high (indicative of Leader dimming being activated) or a SYNC signal 211 has been detected at synchronization terminal 206f from the other LED driver. If either or both conditions are true, clock circuit 206 asserts the COMP_S/H signal 213 logic high. The switching converter controller 204 enables its error amplifier if the COMP_S/H signal 213 is logic high and that that switching converter controller’s LED driver is the Leader LED driver. FIGS. 3 and 4 are block diagrams of clock circuit 206 and switching converter controller 204 to further illustrate this behavior.

Referring to FIG. 3, clock circuit 206 includes an oscillator 302, AND gates 304, 306, and 308, OR gate 312, rising edge one-shot circuit 314, falling edge one-shot circuit 316, clock sample circuit 318, and multiplexers 320 and 322. Control input 206a, which provides the Follower_Leader signal 201, is coupled to an inverted input 306a of AND gate 306, to an inverted input 304b of AND gate 304, to input 310b of AND gate 310, and to a selection (S) input of multiplexer 322. Oscillator 302 generates an oscillator clock 303 at its output, which is coupled to the input 306b of AND gate 306, to an input 304a of AND gate 304, and to the 0-input of multiplexer 320. The output of AND gate 306 is coupled to an input 308b of AND gate 308. Control input 206c, which provides the Follower_Dimming signal 205, is coupled to an input 308a of AND gate 308. The output of AND gate 308 is coupled to the synchronization terminal 206f and to an input 310a of AND gate 310 and to the 1-input of multiplexer 320.

The output of AND gate 310 is coupled to the input 318a of clock sample circuit 318. Clock sample circuit 318 generates a signal Leader_Sync_Flag 319 at its output 318b which is coupled to the selection input of multiplexer 320 and to an input 312a of OR gate 312. The output of multiplexer 320 is coupled to an input 316a of falling one-shot circuit 316. The output 316b of falling edge one-shot circuit 316 provides a signal Leader_Clock 315 and is coupled to the 1-input of multiplexer 322.

The output of AND gate 304 is coupled to an input 314a of rising edge one-shot circuit 314. The output 314b of one-shot circuit 314 provides a signal Follower_Clock signal 317 and is coupled to the 0-input of multiplexer 322. Control input 206b, which provides the Leader_Dimming signal 203, is coupled to an input 31b of OR gate 312. OR gate 312 generates the COMP_S/H signal 213 at its output.

If the LED driver 120 is configured to be the follower, Follower_Leader signal 201 is a logic 0, which allows the oscillator clock 303 to pass through AND gate 306 to the input 308b of AND gate 308. If the Follower_Dimming signal 205 is logic high, which indicates that MCU 110 has activated PWM dimming for the follower LED driver, then the oscillator clock 303 also passes through AND gate 308 as the SYNC signal 211 to the other LED driver, which is the leader LED driver.

The oscillator clock 303 also passes through AND gate 304 to the input 314a of rising edge one-shot circuit 314. Rising edge one-shot circuit 314 generates an output pulse as the Follower_Clock signal 317 in response to a rising edge at its input 314a. Being a logic 0, the Follower_Leader signal 201 causes the 0-input of multiplexer 322 to be selected thereby causing the Follower_Clock signal 317 to pass through multiplexer 322 as the CLOCK_OUT signal 209.

If the LED driver 120 is configured to be the leader, Follower_Leader signal 201 is a logic 1, which causes AND gate 306 to gate off the oscillator clock 303 from reaching AND gate 308. Instead, if MCU 110 has activated PWM dimming for the follower LED driver 120, the synchronization terminal 206f of the leader LED driver’s lock circuit 206 will receive the SYNC signal 211 from the follower LED driver. The SYNC signal 211 passes through AND gate 310 to input 318a of clock sample circuit 318.

Clock sample circuit 318 determines whether a clock signal is present at its input 318a or absent from input 318a. In one example, clock sample circuit 318 samples its input signal at a rate that is faster than the frequency of the oscillator clock 303. If a clock (e.g., the SYNC signal 211) is detected at the input 318a, clock sample circuit 318 generates the Leader_Sync_Flag 319 to be a logic 1. If no clock is detected at the input 318a, sample circuit 318 generates the Leader_Sync_Flag 319 to be a logic 0.

If a SYNC signal 211 is present at the synchronization terminal 206f, clock sample circuit 318 generates the Leader_Sync_Flag 319 to be a logic 1, which causes the 1-input of multiplexer 320 to be selected. The 1-input of multiplexer 320 receives the SYNC signal 211 and, accordingly, the output of multiplexer 320 is the SYNC signal 211. The SYNC signal from multiplexer 320 is provided to input 316a of falling edge one-shot circuit 316. Falling edge one-shot circuit 316 generates an output pulse as the Leader_Clock signal 315 in response to a falling edge at its input 316a. Accordingly, the Leader_Clock signal 316 is approximately 180 degrees out-of-phase with respect to the Follower_Clock 317 generated within the follower PWM driver. Follower_Leader signal 201 being a logic 1 also causes the 1-input of multiplexer 322 to be selected thereby causing multiplexer 322 to output the Leader_Clock signal 315 as CLOCK_OUT signal 209 the leader PWM LED driver’s switching converter controller 204.

FIG. 4 includes a block diagram of switching converter controller 204, in example. Switching converter controller 204 includes a ramp generator 402, a summer 404, a comparator 406, a set (S)-reset (R) latch 408 (SR latch 408), a gate driver 410, a transistor M1 (e.g., an n-channel field effect transistor (NFET)), an error amplifier 412, an AND gate 414, a switch SW1 (e.g., a transistor), a resistor R41, and a capacitor C41. Clock input 204a is coupled to an input 402a of ramp generator 402 and to the S input of SR latch 408. The output 402b is coupled to an input 404a of summer 404. A feedback input 204f (not shown in FIG. 2) is coupled to an input 412a of error amplifier 412. A reference voltage REF (e.g., from a reference voltage generator circuit) is provided to an input 412b of error amplifier 412. Switch SW1 has switch terminals SW1_a and SW1_b, and a control terminal SW_c. Switch terminal SW1_a is coupled to the output 412c of error amplifier 412. The error amplifier 412 produces a signal COMP 413 at its output by amplifying the difference between the voltages at its inputs 412a and 412b (e.g., the difference between the feedback voltage and the reference voltage REF). The switch terminal SW1_b is coupled to the input 404b of summer 404. Resistor 411 and capacitor C41 are coupled in series between the switch terminal SW1_b and ground. One terminal of an external capacitor, such as capacitor C2 in FIG. 1, can be coupled to the switch terminal SW1_b and thus across the series connection of resistor R41 and capacitor C41.

An input 414a of AND gate 414 is coupled to control input 204c, and an input 414b is coupled to control input 204d. Accordingly, AND gate 414 logically ANDs the Leader_Follower signal 201 and the COMP_S/H signal 213. The output of AND gate 414 is coupled to the control input SW1_c of switch SW1. In this example, when the signal at the output of AND gate 414 is a logic ‘1’, switch SW1 closes, and when the signal from AND gate 414 is a logic ‘0’, switch SW1 opens. With switch SW1 closed, capacitor C41 charges based on the COMP signal 413 (e.g., a current from the error amplifier based on the difference between the feedback voltage and the reference voltage REF). When switch SW1 opens, the COMP signal 413 is held across the series connection of resistor R41 and capacitor C41.

Ramp generator 402 generates a ramp signal 403 based on the CLOCK_OUT signal 209. For example, ramp generator 402 may charge a capacitor internal to the ramp generator when the CLOCK_OUT signal 209 is logic low and discharge/reset the capacitor when the CLOCK_OUT signal 209 is logic high. Summer 404 subtracts the ramp signal 403 from signal COMP 413. Comparator 406 compares the output signal from summer 404 to a signal at the switching terminal 204b. The output of comparator 406 is coupled to an input of gate driver 410, and the output of gate driver 410 is coupled to the gate of transistor M1. A rising edge of the CLOCK_OUT signal 209 sets SR latch 408 thereby causing transistor M1 to turn on. When the voltage level of at the switching terminal 204b exceeds the output signal from summer 404, comparator 406 forces its output signal high thereby resetting SR latch 408 which results in transistor M1 turning off.

If the LED driver 120 is programmed to operate as the follower, the Leader_Follower signal 201 will be a logic ‘0’ which forces AND gate 414 to output a logic ‘0’ thereby causing switch SW1 to open and disable error amplifier 412 in the follower LED driver 120.

If the LED driver 120 is programmed to operate as the leader, the Leader_Follower signal 201 will be a logic ‘1’ and the output signal from AND gate 414 will be a logic ‘1’, which enables the leader LED driver’s error amplifier if the COMP_S/H signal 213 also is a logic ‘1.’ As described above, the COMP_S/H signal 213 will be a logic ‘1’ when either or both of the Leader Dimming signal 213 is a logic ‘1’ (indicative of Leader dimming being activated) or the SYNC signal 211 has been detected at synchronization terminal 206f from the follower LED driver. In the leader LED driver 120, the error amplifier 412 will be disabled when neither the Leader Dimming signal 213 is a logic ‘1’ nor a SYNC signal 211 is detected at the synchronization terminal 206f. In other words, when MCU 110 has deactivated PWM dimming for both the leader LED driver and the follower LED driver, the leader LED driver’s error amplifier will be disabled because power from the switching converter is not needed. By opening switch SW1 to disable the leader LED driver’s error amplifier 412, the COMP signal 413 is sampled and held across the series connection of resistor R41 and capacitor 41 and continues to be provided to the input 404b of summer 404.

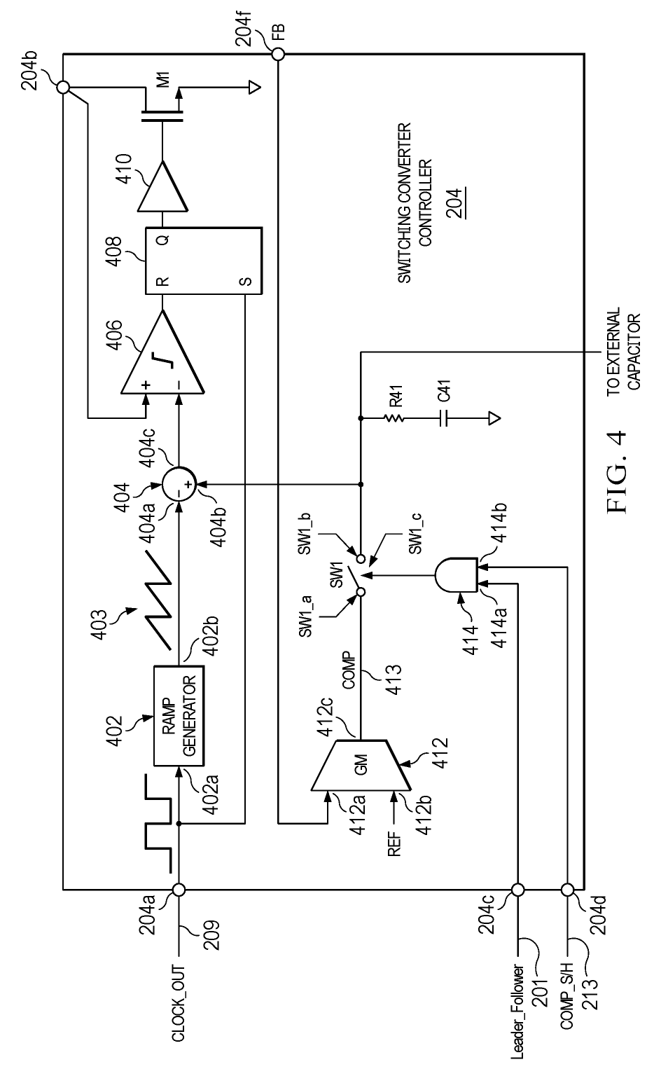

FIG. 5 is a flowchart 500 illustrating the operation of the LED driver 120 that is configured to be the follower. At operation 502, the follower LED driver’s clock circuit 206 generates the clock (e.g., Follower_Clock signal 317) for use by the follower’s switching converter controller 204. The Follower_Clock signal 317 is provided through multiplexer 322 as CLOCK_OUT signal 209. Decision operation 504 determines whether follower dimming is activated. This determination can be made by control logic circuit 202 in the follower LED driver 120 determining whether an active PWM signal is being provided to the control logic circuit 202 by MCU 110. If follower dimming is active (the “yes” branch), then at operation 506, the follower LED driver 120 provides a clock to the leader LED driver via the EN/SYNC terminals 122a_2/122b_2. If follower dimming is not active (the “no” branch), then at operation 508, the follower LED driver 120 does not provide a clock to the leader LED driver.

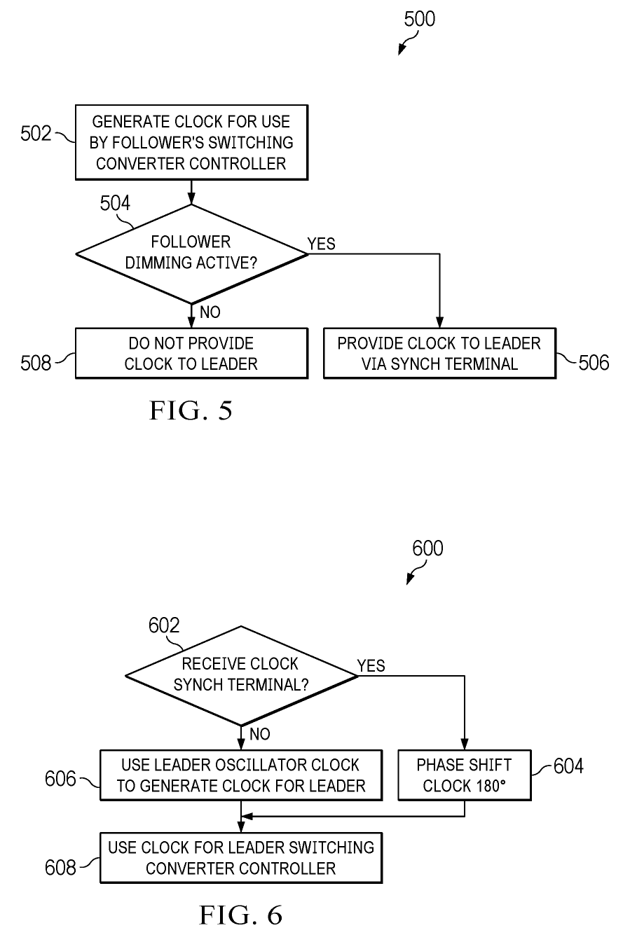

FIG. 6 is a flowchart 600 illustrating the operation of the LED driver 120 that is configured to be the leader. At operation 602, the leader LED driver 120 determines whether it has received a clock at its SYNC terminal (e.g., EN/SYNC terminal 122a_2/122b_2). In an example, the leader LED driver’s clock sample circuit 318 makes this determination, as described above. If a clock has been received at the EN/SYNC terminal, the leader LED driver 120 phase-shifts the received clock by approximately 180 degrees. In an example, the leader LED driver’s falling edge one-shot circuit 316 performs the 180-degree phase shift operation. If a clock has not been received at the EN/SYNC terminal, the leader LED driver 120 generates a clock using the oscillator clock from its own internal oscillator. In either case, at operation 608, the leader LED driver 120 uses the clock (either the phase-shifted clock from operation 604 or the internally-generated clock from operation 606 for the leader LED driver’s switching converter controller 204.

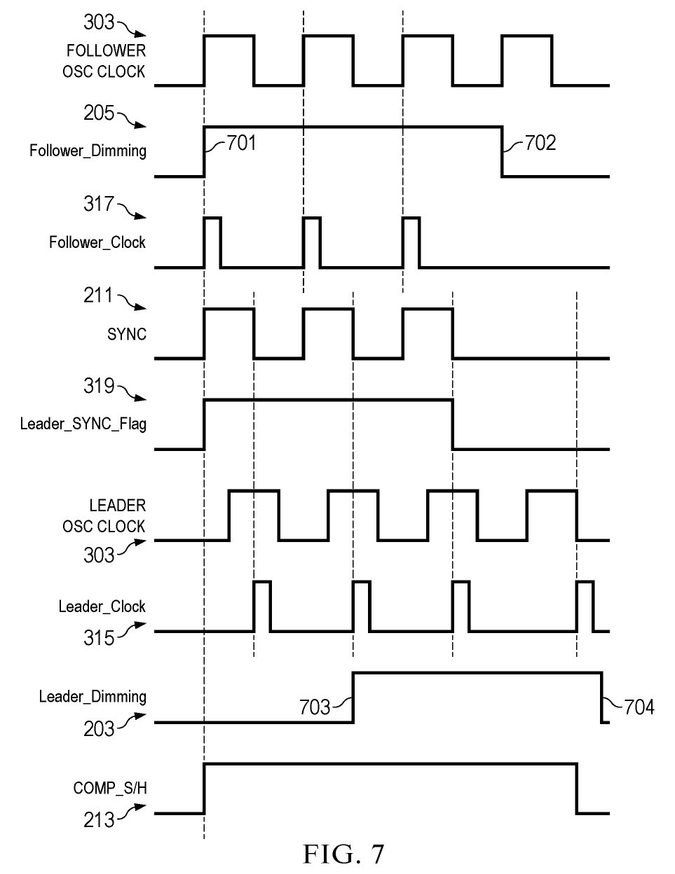

FIGS. 7-11 are timing diagrams illustrating different operations of illumination system 100 in terms of when PWM dimming is activated or deactivated to the leader LED driver and to the follower LED driver. FIG. 7 illustrates an illumination system 100 operation in which leader dimming overlaps with follower dimming. The signals illustrated in FIG. 7 include both the follower and leader LED drivers’ oscillation clocks 303, the Follower_Dimming signal 205, the SYNC signal 211, the Leader_SYNC_Flag 319, the Leader_Clock 315, the Leader_Dimming signal 205, and the COMP_S/H signal 213. In this example, follower dimming is activated between the rising edge 701 of the Follower_Dimming signal 205 and the falling edge 702 of the Follower_ Dimming signal 205. Leader dimming begins at rising edge 703 of the Leader_Dimming signal 203, and while Follower dimming is already active, and ends at falling edge 704 of the Leader_Dimming signal 203, and accordingly after follower dimming has already ended. Clock circuit 206 in the follower LED driver generates clock pulses for the Follower_Clock signal 317 while follower dimming is active and then ceases producing the Follower_Clock signal pulses when follower diming ends. The follower LED driver 120 produces pulses for the SYNC signal 211 based on the follower oscillator clock 303 while follower dimming is active and then ceases producing SYNC signal pulses when follower dimming ends. During follower dimming, the leader LED driver produces pulses for the Leader_Clock 315 based on the received SYNC signal pulses (e.g., based on the SYNC signal pulse falling edges) from the follower LED driver. When follower dimming ends (as marked by falling edge 702), the SYNC signal pulses cease and the leader LED driver 120 continues producing pulses for the Leader_Clock 315 based on the leader LED driver’s own oscillator clock 303. The COMP_S/H signal 213 is logic high while either (a) pulses are present for the SYNC signal 211 or (b) leader dimming is active.

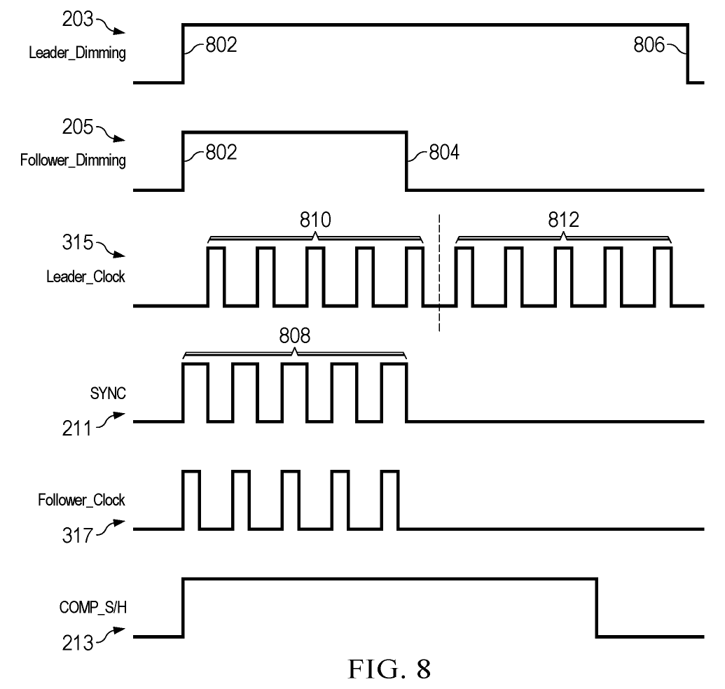

FIG. 8 is an example in which both leader and follower dimming begin at the same time (as identified by rising edges 802 of the corresponding Leader_Dimming signal 203 and Follower_Dimming signal 205. In this case, follower dimming ends (falling edge 804 of Follower_Dimming signal 205) before leader dimming ends (falling edge 806 of Leader_Dimming signal 203). Clock circuit 206 in the follower LED driver generates clock pulses for the Follower_Clock signal 317 while follower dimming is active and then ceases producing the Follower_Clock signal pulses when follower diming ends. During follower dimming, the leader LED driver produces pulses 810 for the Leader_Clock 315 based on the received SYNC signal pulses 808 from the follower LED driver. When follower dimming ends (as marked by falling edge 804), the SYNC signal pulses cease and the leader LED driver 120 continues producing pulses for the Leader_Clock 315 based on the leader LED driver’s own oscillator clock 303. The COMP_S/H 213 signal is logic high while either (a) pulses are present for the SYNC signal 211 or (b) leader dimming is active, which in this case persists the length of active leader dimming.

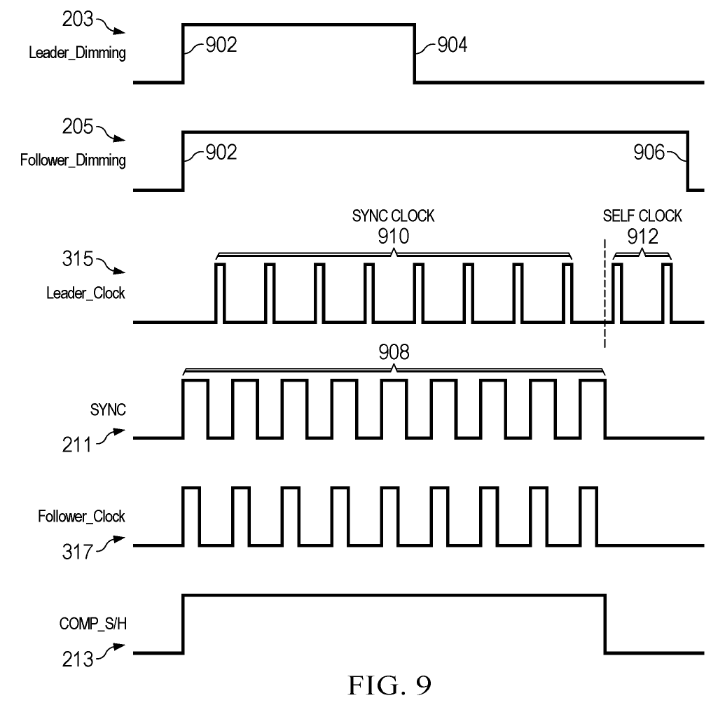

FIG. 9 is an example in which both leader and follower dimming begin at the same time (as identified by rising edges 902 of the corresponding Leader_Dimming signal 203 and Follower_Dimming signal 205, but leader dimming ends (falling edge 904 of Leader_Dimming signal 203) before follower dimming ends (falling edge 906 of Follower_Dimming signal 205). Clock circuit 206 in the follower LED driver generates clock pulses for the Follower_Clock signal 317 while follower dimming is active and then ceases producing the Follower_Clock signal pulses when follower diming ends. During follower dimming, the leader LED driver produces pulses 910 for the Leader_Clock 315 based on the received SYNC signal pulses 908 from the follower LED driver. When follower dimming ends (as marked by falling edge 906), the SYNC signal pulses cease and the leader LED driver 120 continues producing pulses 912 for the Leader_Clock 315 based on the leader LED driver’s own oscillator clock 303. The COMP_S/H 213 signal is logic high while either (a) pulses are present for the SYNC signal 211 or (b) leader dimming is active, which in this case persists the length of active follower dimming.

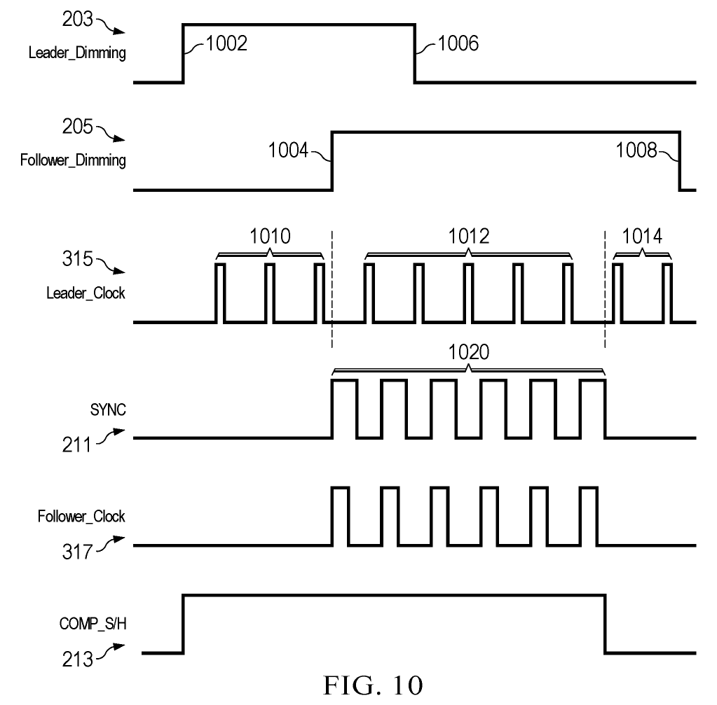

FIG. 10 is an example in which leader and follower dimming overlap but leader dimming begins (as indicated by rising edge 1002 of the Leader_Dimming signal 203) before follower dimming (as indicated by rising edge 1004 of the Follower_Dimming signal 205), and leader dimming ends (as indicated by falling edge 1006 of the Leader_Dimming signal 203) before follower dimming ends (as indicated by falling edge 1008 of the Follower_Dimming signal 205). Clock circuit 206 in the leader LED driver 120 generates pulses 1012 based on the received SYNC signal 211 pulses 1020 and generates pulses 1010 and 1014 otherwise using its own internal oscillator clock 303. The COMP_S/H 213 signal persists logic high from the beginning of leader dimming to the end of follower dimming.

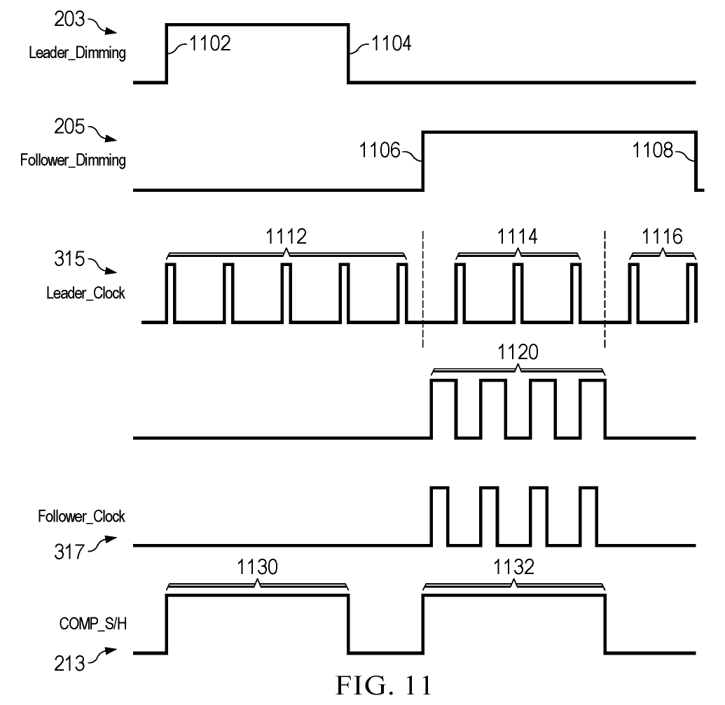

FIG. 11 is an example in which leader and follower dimming do not overlap and leader dimming occurs between rising and falling edges 1102 and 1104 of the Leader_Dimming signal 203 before follower dimming, which occurs between rising and falling edges 1106 and 1108 of the Follower_Dimming signal 205. Clock circuit 206 in the leader LED driver 120 generates pulses 1114 based on the received SYNC signal 211 pulses 1120 and generates pulses 1112 and 116 otherwise using its own internal oscillator clock 303. The COMP_S/H 213 signal persists logic high at 1130 during leader dimming and again at 1132 during follower dimming.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field effect transistor (“FET”) (such as an n-channel FET (NFET) or a p-channel FET (PFET)), a bipolar junction transistor (BJT – e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor’s control input and its current terminals. In the context of a FET, the control input is the gate, and the current terminals are the drain and source. In the context of a BJT, the control input is the base, and the current terminals are the collector and emitter.

References herein to a FET being “ON” or “enabled” means that the conduction channel of the FET is present and drain current may flow through the FET. References herein to a FET being “OFF” or “disabled” means that the conduction channel is not present so drain current does not flow through the FET. An “OFF” FET, however, may have current flowing through the transistor’s body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/- 10 percent of that parameter or, if the parameter is zero, a reasonable range of values around zero.

Modifications are possible in the described examples, and other examples are possible, within the scope of the claims.

What is claimed is:

1. An apparatus, comprising:
a control logic circuit having a configuration input, a pulse width modulation (PWM) input, a first control output, a second control output, and a third control output, the configuration input configured to receive a configuration value indicative of a first status or a second status, the control logic configured to generate a first signal at the first control output indicative of the first status or the second status, a second signal at the second control output indicative of a first dimming status, and a third signal at the third control output indicative of a second dimming status;
a switching converter controller having a clock input; and
a clock circuit including an oscillator configured to generate an oscillator clock, the clock circuit having a first control input, a second control input, a third control input, a clock output, and a synchronization terminal, the clock output coupled to the clock input, the clock circuit configured to:
in response to the first status, generate a first clock at the clock output based on a synchronization clock received at the synchronization terminal; and
in response to the second status, generate the first clock at the clock output based on the oscillator clock and generate a synchronization clock at the synchronization terminal also based on the oscillator clock.

2. The apparatus of claim 1, further comprising:
a first one-shot circuit having an input coupled to the synchronization terminal, the first one-shot circuit configured to generate an output pulse based on of a falling edge of the synchronization clock received at the synchronization terminal; and
a second one-shot circuit having an input coupled to the oscillator, the second one-shot circuit configured to generate an output pulse based on a rising edge of the oscillator clock.

3. The apparatus of claim 1, wherein the clock circuit includes a clock sample circuit having an input coupled to the synchronization terminal and having an output, the clock sample circuit configured to generate a flag to indicate whether the synchronization clock is present at the synchronization terminal.

4. The apparatus of claim 1, wherein the switching converter controller includes:
an error amplifier having an error amplifier output;
a switch having a first switch terminal, a second switch terminal, and a control terminal, the first switch terminal coupled to the error amplifier output; and
a resistor coupled in series with a capacitor between the second switch terminal and a supply voltage terminal.

5. The apparatus of claim 4, further comprising a logic gate having a first logic gate input, a second logic gate input, and a logic gate output, the first logic gate input coupled to the first control output, the second logic gate input configured to receive a second signal, and the logic gate output coupled to the control terminal of the switch.

6. The apparatus of claim 1, wherein the switching converter controller has a switching terminal, and the apparatus further comprises
a power stage circuit having a power stage circuit terminal coupled to the switching terminal, the power stage circuit also having an output terminal; and
an illumination device coupled to the output terminal.

7. An apparatus, comprising:
a control logic circuit having a configuration input, a pulse width modulation (PWM) input, a first control output, a second control output, and a third control output, the configuration input configured to receive a configuration value indicative of a first status or a second status, the control logic configured to generate a first signal at the first control output indicative of the first status or the second status, a second signal at the second control output indicative of a first dimming status, and a third signal at the third control output indicative of a second dimming status;
a clock circuit including an oscillator configured to generate an oscillator clock, the clock circuit having a first control input, a second control input, a third control input, a clock output, and a synchronization terminal, the clock circuit configured to:
in response to the first status, generate a first clock at the clock output based on a synchronization clock received at the synchronization terminal; and
in response to the second status, generate the first clock at the clock output based on the oscillator clock and generate a synchronization clock at the synchronization terminal also based on the oscillator clock.

8. The apparatus of claim 7, further comprising a switching converter controller having a clock input, and wherein the clock output of the clock circuit is coupled to the clock input of the switching converter controller.

9. The apparatus of claim 8, wherein the switching converter controller includes:
an error amplifier having an error amplifier output;
a switch having a first switch terminal, a second switch terminal, and a control terminal, the first switch terminal coupled to the error amplifier output; and
a resistor coupled in series with a capacitor between the second switch terminal and a supply voltage terminal.

10. The apparatus of claim 8, wherein the switching converter controller has a switching terminal, and the apparatus further comprises
a power stage circuit having a power stage circuit terminal coupled to the switching terminal, the power stage circuit also having an output terminal; and
an illumination device coupled to the output terminal.

11. The apparatus of claim 7, further comprising:
a first one-shot circuit having an input coupled to the synchronization terminal, the first one-shot circuit configured to generate an output pulse based on of a falling edge of the synchronization clock received at the synchronization terminal; and
a second one-shot circuit having an input coupled to the oscillator, the second one-shot circuit configured to generate an output pulse based on a rising edge of the oscillator clock.

12. The apparatus of claim 7, wherein the clock circuit includes a clock sample circuit having an input coupled to the synchronization terminal and having an output, the clock sample circuit configured to generate a flag at the output of the clock sample circuit to indicate whether the synchronization clock is present at the synchronization terminal.

13. An illumination system, comprising:
a first light emitting diode (LED) driver having a first configuration interface and a first switching converter controller, and having a first LED output terminal, the first LED driver configured to be either a leader or a follower based on configuration information received at the first configuration interface;
a first power stage coupled to the first LED driver and having a first output voltage terminal;
a first set of LEDs coupled between the first output voltage terminal and the first LED output terminal;
a second LED driver having a second configuration interface and a second switching converter controller, and having a second LED output terminal, the second LED driver configured to be the other of the leader or follower based on configuration information received at the second configuration interface;
a second power stage coupled to the second LED driver and having a second output voltage terminal coupled to the first output voltage terminal; and
a second set of LEDs coupled between the second output voltage terminal and the second LED output terminal; and
wherein whichever of the first or second LED drivers is configured to be the follower, such first or second LED driver is configured to generate a first clock for its respective first or second switching converter controller and to provide a second clock to the other of the first or second LED drivers configured to the leader.

14. The illumination system of claim 13, wherein whichever of the first or second LED drivers is configured to be the leader, such first or second LED driver is configured to generate a third clock for its respective first or second switching converter controller based on the second clock from the first or second LED driver configured to be the follower.

15. The illumination system of claim 14, wherein the first or second LED drivers configured to be the leader includes an oscillator and is configured to detect an absence of the second clock and, in response to detection of the absence of the second clock, generate the third clock based on an oscillator clock from the oscillator.

16. The illumination system of claim 14, wherein whichever of the first or second LED drivers is configured to be the leader, such first or second LED driver is configured to generate the third clock approximately at 180 degrees out of phase with respect to the second clock.

17. The illumination system of claim 13, wherein each of the first and second switching converter controllers has a respective error amplifier, and the error amplifier of one of the leader or follower is configured to be enabled while the other error amplifier is configured to be disabled.

18. An illumination system, comprising:
a first light emitting diode (LED) driver having a first configuration interface and a first switching converter controller, and having a first LED output terminal, the first LED driver configured to be either a leader or a follower based on configuration information received at the first configuration interface;
a first power stage coupled to the first LED driver and having a first output voltage terminal;
a first set of LEDs coupled between the first output voltage terminal and the first LED output terminal;
a second LED driver having a second configuration interface and a second switching converter controller, and having a second LED output terminal, the second LED driver configured to be the other of the leader or follower based on configuration information received at the second configuration interface;
a second power stage coupled to the second LED driver and having a second output voltage terminal coupled to the first output voltage terminal; and
a second set of LEDs coupled between the second output voltage terminal and the second LED output terminal; and
wherein whichever of the first or second LED drivers is configured to be the leader, such first or second LED driver is configured to generate a first clock for its respective first or second switching converter controller based on a second clock received from the other of the first or second LED drivers that configured to the follower.

19. The illumination system of claim 18, wherein whichever of the first or second LED drivers is configured to be the follower, such first or second LED driver is configured to generate a third clock for its respective first or second switching converter controller and to provide the second clock to the other of the first or second LED drivers configured to the leader.

20. The illumination system of claim 18, wherein the first or second LED drivers configured to be the leader includes an oscillator and is configured to detect an absence of the second clock and, in response to detection of the absence of the second clock, generate the first clock based on an oscillator clock from the oscillator.

21. The illumination system of claim 19, wherein whichever of the first or second LED drivers is configured to be the leader, such first or second LED driver is configured to generate the first clock at approximately 180 degrees out of phase with respect to the second clock.
